(19) United States
(12) Patent Application Publication
(10) Pub. No.: US 2015/0205473 A1
(43) Pub. Date: Jul. 23, 2015

(54) SYSTEMS AND METHODS FOR VISUALLY SCROLLING THROUGH A STACK OF ITEMS DISPLAYED ON A DEVICE

(71) Applicants: Arnaud Claude Weber, Saratoga, CA (US); Alex Neely Ainslie, San Francisco, CA (US); John Nicholas Jitkoff, Palo Alto, CA (US); Roma Rajni Shah, San Francisco, CA (US); Jerome F. Scholler, San Francisco, CA (US)

(72) Inventors: Arnaud Claude Weber, Saratoga, CA (US); Alex Neely Ainslie, San Francisco, CA (US); John Nicholas Jitkoff, Palo Alto, CA (US); Roma Rajni Shah, San Francisco, CA (US); Jerome F. Scholler, San Francisco, CA (US)

(73) Assignee: GOOGLE INC., Mountain View, CA (US)

(21) Appl. No.: 13/312,865

(22) Filed: Dec. 6, 2011

(51) Int. Cl. G06F 3/0485; G06F 3/0484; G06F 3/0482

(52) U.S. Cl. CPC G06F 3/0485; G06F 3/0482; G06F 3/04842

(57) ABSTRACT

Systems and methods for visually scrolling through a stack of items displayed on a device are provided. In some aspects, a system includes a detection module configured to determine a motion of the device relative to a neutral position of the device. The system also includes a display module configured to visually scroll through the stack of items in response to the motion of the device.

### FIELD

The subject technology generally relates to scrolling and, in particular, relates to systems and methods for visually scrolling through a stack of items displayed on a device.

### BACKGROUND

A touch-based device such as a smartphone may allow a user to scroll through content by using the user's finger gestures. For example, while touching a screen of the touch-based device with the user's finger, the user may slide the finger in an upward direction to move the content in the upward direction or may slide the finger in a downward direction to move the content in the downward direction. Unfortunately, if the user desires to scroll through a large amount of content, the user may need to apply repeated finger gestures to scroll through the large amount of content. Thus, it is desirable to scroll through content without necessarily relying on the user's finger gestures for the scrolling.

### SUMMARY

According to various aspects of the subject technology, a system for visually scrolling through a stack of items displayed on a device is provided. The system comprises a detection module configured to determine a motion of the device relative to a neutral position of the device. The system also comprises a display module configured to visually scroll through the stack of items in response to the motion of the device.

According to various aspects of the subject technology, a computer-implemented method for visually scrolling through a stack of items displayed on a device is provided. The method comprises determining a motion of the device relative to a neutral position of the device. The method also comprises visually scrolling through the stack of items in response to the motion of the device.

According to various aspects of the subject technology, a machine-readable medium encoded with executable instructions for visually scrolling through a stack of items displayed on a device is provided. The instructions comprise code for displaying the stack of items on the device. Each of the stack of items comprises at least one of a window, a browser tab, a contact page, a document, and an image. The instructions also comprise code for establishing a neutral position of the device and code for determining a motion of the device relative to the neutral position. The instructions also comprise code for visually scrolling through the stack of items in response to the motion of the device. A direction of the scrolling corresponds to a direction of a tilt of the motion of the device.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for visually scrolling through a stack of items displayed on a device, in accordance with various aspects of the subject technology.

FIG. 2 illustrates an example of a method for visually scrolling through a stack of items displayed on a device, in accordance with various aspects of the subject technology.

FIGS. 3A, 3B, and 3C illustrate an example of a device, in accordance with various aspects of the subject technology.

FIG. 4 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

Touch-based mobile devices such as smartphones and tablets are typically equipped with small screens compared to other computing devices like laptop computers and desktop computers. In this regard, items displayed on the touch-based mobile devices can be stacked on top of one another in order to save space and accommodate the smaller screens. Items that may be stacked include windows, browser tabs, contact pages, documents, images, and other suitable items in a frame format. For example, a mobile device may display multiple windows stacked on top of one another, and a user may select a particular window to be displayed by rearranging the stack of multiple windows or manipulating the stack in some other manner. U.S. patent application Ser. No. 13/094,489, filed on Apr. 26, 2011 and entitled “Mobile Browser Context Switching,” describes various examples of stacked items and is incorporated by reference herein.

The mobile devices are typically equipped with accelerometers. Aspects of the subject technology take advantage of the accelerometers in order to provide a user of a mobile device with an optimized experience for navigating through a stack of items displayed on the mobile device. According to certain aspects, the user may visually scroll through the stack of items by moving the mobile device in an appropriate manner. For example, if the user tilts the mobile device forward (assuming the mobile device is in a portrait mode (e.g., when the screen of the mobile device is oriented vertically from the user's perspective and may be taller than it is wide)), the stack of items may be visually scrolled through in an upward direction relative to the screen of the mobile device, thereby allowing the user to quickly view the contents of each of the items as the items move upward without necessarily having to rely on the user's finger gestures for the scrolling. If the user tilts the phone backward (assuming the mobile device is in the portrait mode), the stack of items may be visually scrolled through in a downward direction relative to the screen of the mobile device. The stack of items may be visually scrolled through in a similar manner when the mobile device is in a landscape mode (e.g., when the screen mobile device is oriented horizontally from the user's perspective and may be wider than it is tall), except that the stack of items may be visually scrolled through toward the left or the right relative to the screen depending on how the user tilts the phone. According to certain aspects, either type of scrolling (e.g., upward/downward scrolling or left/right scrolling) may be employed for mobile devices with square screens.

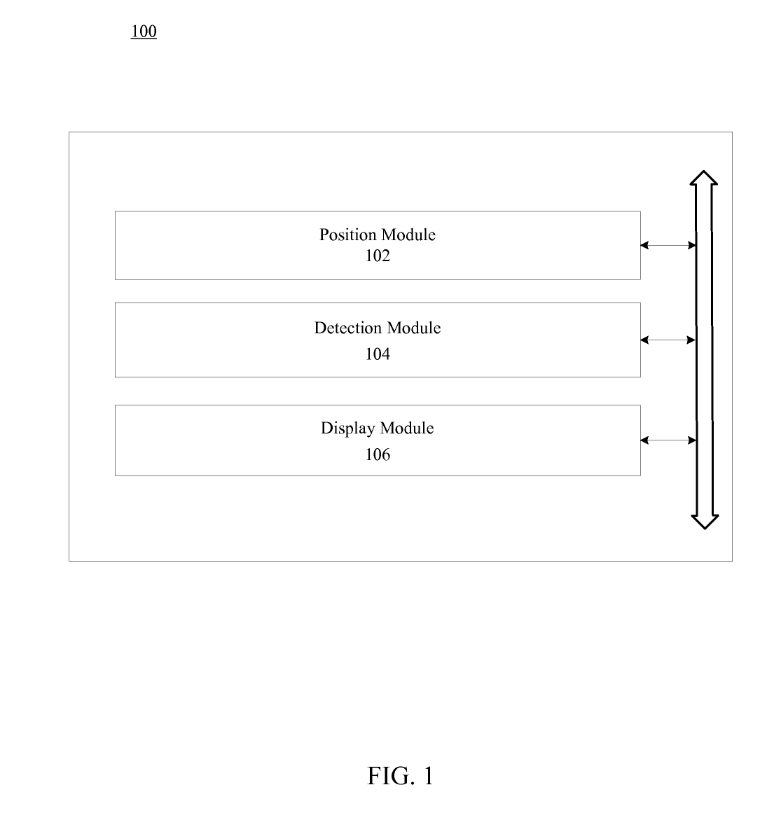

FIG. 1 illustrates an example of system 100 for visually scrolling through a stack of items displayed on a device, in accordance with various aspects of the subject technology. System 100 comprises position module 102, detection module 104, and display module 106. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

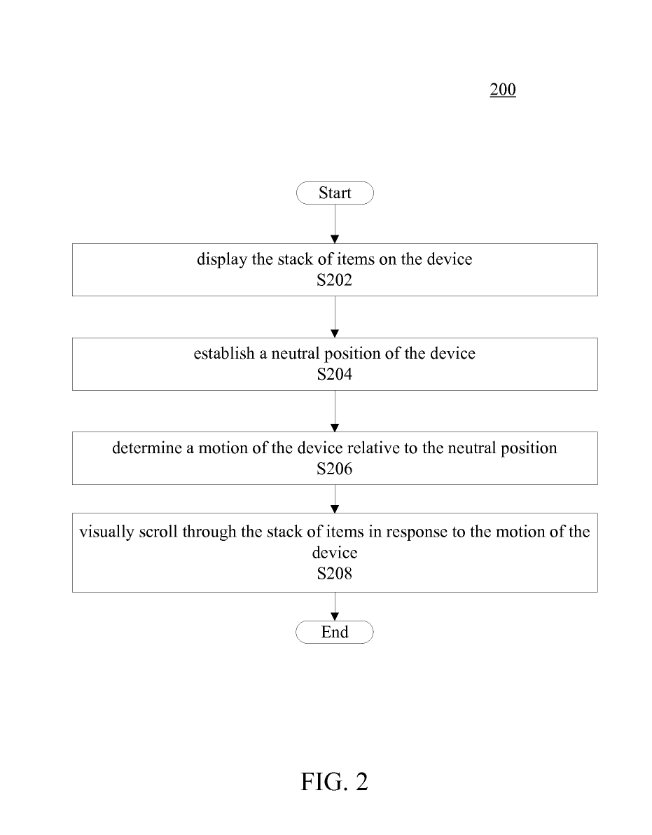

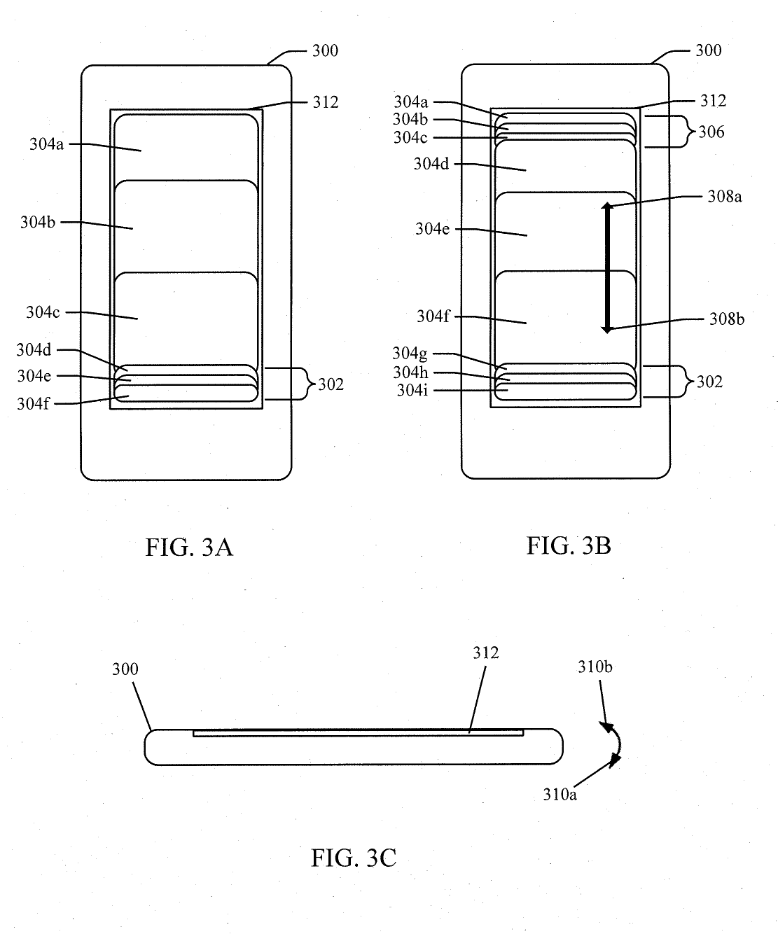

FIG. 2 illustrates an example of method 200 for visually scrolling through a stack of items displayed on a device, in accordance with various aspects of the subject technology. FIGS. 3A, 3B, and 3C illustrate an example of device 300, in accordance with various aspects of the subject technology. FIGS. 3A and 3B illustrate a front view of device 300, while FIG. 3C illustrates a side view of device 300. As shown in FIGS. 3A, 3B, and 3C, device 300 comprises a mobile phone. However, device 300 may comprise any suitable device with an accelerometer, such as a tablet computer and a personal digital assistant.

According to step S202 in FIG. 2, display module 106 may display stack of items 302 on device 300. As shown in FIG. 3A, stack of items 302 is displayed on screen 312 of device 300. Stack of items 302 comprises items 304d, 304e, and 304f. For example, item 304f is overlaid on top of item 304e, which is overlaid on top of item 304d. Display module 106 also displays other items 304a, 304b, and 304c. Each of the items displayed may comprise at least one of a window, a browser tab, a contact page, a document, an image, and other suitable content in a frame format. For example, each of the items may be a browser tab that displays a different webpage. Items 304a, 304b, and 304c are shown in FIG. 3A in an expanded state compared to items 304d, 304e, and 304f. For example, each of the expanded items (e.g., items 304a, 304b, and 304c) displays more content than a collapsed one of the stack of items (e.g., items 304d, 304e, and 304f). According to various aspects of the subject technology, stack of items 302 may be visually scrolled through such that one or more of the stack of items 302 may be expanded and/or unstacked in order to allow a user of device 300 to view the content of the expanded and/or unstacked items.

Prior to visually scrolling through stack of items 302, however, position module 102 may establish a neutral position of device 300 according to step S204 in FIG. 2. Because device 300 may be moved in various positions by a user of device 300, the neutral position of device 300, for example, may be used as a point of reference from which to begin visually scrolling stack of items 302. In some aspects, the scrolling of stack of items 302 may be a function of the angular displacement of device 300 (e.g., the amount of scrolling may be directly proportional to the amount of angular displacement of device 300). In this regard, the neutral position of device 300 may correspond to a zero angular displacement of device 300. Thus, position module 102 may establish the neutral position of device 300 by resetting an angular displacement of device 300 to zero.

According to certain aspects, user input received from the user of device 300 may be used to establish the neutral position. The user input, for example, may comprise at least one of a touch-based input, a button-based input, or other suitable user input. This user input may indicate that the user is using device 300 and does not wish to visually scroll through stack of items 302 based on the movement of device 300. For example, the user may be using finger gestures or button inputs to interact with content displayed on screen 312 of device 300. During this time, the user may not necessarily desire to visually scroll through stack of items 302 based on the movement of device 300, especially if the movement is unintentional. In this regard, detection module 104 may monitor device 300 for the user input and may establish the neutral position of device 300 upon completion of the user input.

According to step S206 in FIG. 2, detection module 104 may determine a motion of device 300 relative to the neutral position of device 300. For example, as shown in FIG. 3C, device 300 may be tilted in the direction of either arrow 310a or arrow 310b. In some aspects, the motion of device 300 may comprise at least one of a velocity of device 300 (e.g., angular velocity) and a displacement of device 300 (e.g., angular displacement). Detection module 104 may receive the velocity from an accelerometer of device 300. Furthermore, detection module 104 may determine the displacement of device 300 relative to the neutral position by multiplying a duration of the motion of device 300 with the angular velocity of device 300.

According to step S208 in FIG. 2, display module 106 may visually scroll through stack of items 302 in response to the motion of device 300. In some aspects, stack of items 302 may be scrolled through based on the angular displacement of device 300. For example, the right side of device 300 shown in FIG. 3C may correspond to a top side of device 300 in FIGS. 3A and 3B. If device 300 is tilted in the direction of arrow 310a in FIG. 3C, then stack of items 302 may be visually scrolled in the direction of arrow 308a in FIG. 3B. Conversely, if device 300 is tilted in the direction of arrow 310b, then stack of items may be visually scrolled in the direction of arrow 308b in FIG. 3B. Scrolling through stack of items 302 in this manner may provide the user with the perception that gravity has an impact on the scrolling, thereby allowing the user to scroll intuitively. Stack of items 302 may be visually scrolled through in a similar manner when device 300 is in a landscape mode, except that stack of items 302 may be visually scrolled through toward the left or the right of screen 312 (when the user is viewing device 300 in landscape mode) depending on how the user tilts device 300. Furthermore, a speed of the scrolling may be proportional to a speed of the motion of device 300 (e.g., the faster the motion, the faster the scrolling may be). Scrolling through stack of items 302 using such a relationship may provide the user with the perception that a centrifugal force has an impact on the scrolling, thereby allowing the user to scroll intuitively.

According to certain aspects, stack of items 302 may be visually scrolled through by unstacking and/or expanding one or more of stack of items 302. For example, FIG. 3B illustrates device 300 after stack of items 302 has been visually scrolled through in the direction of arrow 308a compared to device 300 in FIG. 3A. Compared to items 304a, 304b, and 304c in FIG. 3A, these items in FIG. 3B are visually scrolled in the direction of arrow 308a and collapsed into an unexpanded state to form stack of items 306 at a top of screen 312. Furthermore, while items 304d, 304e, and 304f are collapsed in an unexpanded state in FIG. 3A, these items are visually scrolled in the direction of arrow 308a and expanded as shown in FIG. 3B. As a result of items 304d, 304e, and 304f being expanded in the direction of arrow 308a, new items (e.g., items 304g, 304h, and 304i) are revealed as part of stack of items 302. In some aspects, items may be visually scrolled in the same order as which they are stacked, which allows stack of items 306 to be stacked in a reverse order relative to the order of stack of items 302.

According to various aspects of the subject technology, display module 106 may suspend the scrolling upon the user input (e.g., a touch-based input and/or a button-based input) being detected by detection module 104. For example, as discussed above, detection module 104 may monitor device 300 for the user input. The detection of the user input by detection module 104 may indicate that the user has identified content displayed on screen 312 that the user would like to interact with. Thus, scrolling can be suspended upon detection of the user input to allow the user to interact with the content displayed. For example, as stack of items 302 is being visually scrolled through in the direction of arrow 308a, item 304e may become displayed (e.g., as shown in FIG. 3B). The user may desire to interact with the content of item 304e. In this regard, the user may touch item 304e to select the content of item 304e to be displayed. At this point, display module 106 may suspend the scrolling so that item 304e does not continue visually scrolling to the top of screen 312.

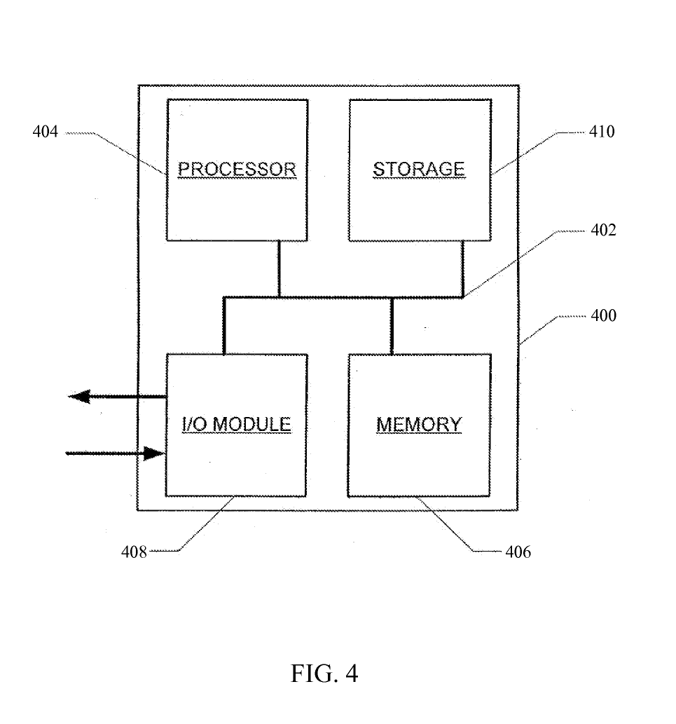

FIG. 4 is a block diagram illustrating components of controller 400, in accordance with various aspects of the subject technology. Controller 400 comprises processor module 404, storage module 410, input/output (I/O) module 408, memory module 406, and bus 402. Bus 402 may be any suitable communication mechanism for communicating information. Processor module 404, storage module 410, I/O module 408, and memory module 406 are coupled with bus 402 for communicating information between any of the modules of controller 400 and/or information between any module of controller 400 and a device external to controller 400. For example, information communicated between any of the modules of controller 400 may include instructions and/or data. In some aspects, bus 402 may be a universal serial bus. In some aspects, bus 402 may provide Ethernet connectivity.

In some aspects, processor module 404 may comprise one or more processors, where each processor may perform different functions or execute different instructions and/or processes. For example, one or more processors may execute instructions for visually scrolling through a stack of items displayed on a device (e.g., method 200), and one or more processors may execute instructions for input/output functions.

Memory module 406 may be random access memory (“RAM”) or other dynamic storage devices for storing information and instructions to be executed by processor module 404. Memory module 406 may also be used for storing temporary variables or other intermediate information during execution of instructions by processor 404. In some aspects, memory module 406 may comprise battery-powered static RAM, which stores information without requiring power to maintain the stored information. Storage module 410 may be a magnetic disk or optical disk and may also store information and instructions. In some aspects, storage module 410 may comprise hard disk storage or electronic memory storage (e.g., flash memory). In some aspects, memory module 406 and storage module 410 are both a machine-readable medium.

Controller 400 is coupled via I/O module 408 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 400 via I/O module 408 for communicating information and command selections to processor module 404.

According to various aspects of the subject disclosure, methods described herein are executed by controller 400. Specifically, processor module 404 executes one or more sequences of instructions contained in memory module 406 and/or storage module 410. In one example, instructions may be read into memory module 406 from another machine-readable medium, such as storage module 410. In another example, instructions may be read directly into memory module 406 from I/O module 408, for example from an operator of system 100 via the user interface. Execution of the sequences of instructions contained in memory module 406 and/or storage module 410 causes processor module 404 to perform methods to visually scroll through a stack of items displayed on a device. For example, a computational algorithm for visually scrolling through a stack of items displayed on a device may be stored in memory module 406 and/or storage module 410 as one or more sequences of instructions. Information such as the motion of the device, the neutral position of the device, the stack of items, the speed of the scrolling, the speed of the motion of the device, the direction of the scrolling, the direction of the motion of the device, the order of the stack of items, the user input, and/or other suitable information may be communicated from processor module 404 to memory module 406 and/or storage module 410 via bus 402 for storage. In some aspects, the information may be communicated from processor module 404, memory module 406, and/or storage module 410 to I/O module 408 via bus 402. The information may then be communicated from I/O module 408 to an operator of system 100 via the user interface.

One or more processors in a multi-processing arrangement may also be employed to execute the sequences of instructions contained in memory module 406 and/or storage module 410. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 404 for execution. Such a medium may take many forms, including, but not limited to, non-volatile media and volatile media. Non-volatile media include, for example, optical or magnetic disks, such as storage module 410. Volatile media include dynamic memory, such as memory module 406. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “right,” “left,” “up,” “down,” “forward,” “backward,” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

1. A system for visually scrolling through a stack of items displayed on a device, the system comprising:
one or more processors; and
a machine-readable medium comprising instructions stored therein, which when executed by the processors, cause the processors to perform operations comprising:
monitoring the device for user input, the user input comprising at least one of a touch-based input or a button-based input;
establishing a neutral position of the device upon completion of the user input;
determining a motion of the device relative to the neutral position of the device; and
visually scrolling through the stack of items in response to the motion of the device.

2. The system of claim 1, wherein the device comprises at least one of a mobile phone, a tablet computer, and a personal digital assistant.

3. The system of claim 1, wherein each of the stack of items comprises at least one of a window, a browser tab, a contact page, a document, and an image.

4. The system of claim 1, wherein the stack of items is overlaid on top of another stack of items.

5. (canceled)

6. The system of claim 5, wherein the neutral position of the device corresponds to a zero angular displacement of the device.

7. The system of claim 1, wherein the motion comprises at least one of a velocity of the device and an angular displacement of the device, and wherein the operations further comprise receiving the velocity from an accelerometer of the device.

8. The system of claim 7, wherein the operations further comprise determining the angular displacement of the device relative to the neutral position based on the velocity of the device, and
wherein the scrolling is based on the angular displacement.

9. The system of claim 1, wherein a speed of the scrolling is proportional to a speed of the motion of the device.

10. The system of claim 1, wherein a direction of the scrolling corresponds to a direction of a tilt of the motion of the device.

11. The system of claim 1, wherein the operations further comprise unstacking the stack of items toward a direction of a tilt of the motion of the device.

12. The system of claim 1, wherein the operations further comprise expanding the stack of items toward a direction of a tilt of the motion of the device, and wherein the expanded stack of items displays more content than an unexpanded stack of items.

13. (canceled)

14. The system of claim 1, wherein the operations further comprise:
monitoring the device for second user input, the second user input comprising at least one of a touch-based input or a button-based input; and
suspending the scrolling upon detection of the second user input.

15. (canceled)

16. A computer-implemented method for visually scrolling through a stack of items displayed on a device, the method comprising:
monitoring the device for user input, the user input comprising at least one of a touch-based input or a button-based input;
establishing a neutral position of the device upon completion of the user input;
determining a motion of the device relative to the neutral position of the device; and
visually scrolling through the stack of items in response to the motion of the device.

17. The method of claim 16, further comprising establishing the neutral position of the device.

18. The method of claim 16, wherein visually scrolling through the stack of items comprises unstacking the stack of items toward a direction of a tilt of the motion of the device.

19. The method of claim 16, further comprising:
monitoring the device for second user input from a user of the device, the second user input comprising at least one of a touch-based input and a button-based input; and
suspending the scrolling upon detection of the second user input.

20. A machine-readable medium encoded with executable instructions for visually scrolling through a stack of items displayed on a device, the instructions comprising code for:
displaying the stack of items on the device, each of the stack of items comprising at least one of a window, a browser tab, a contact page, a document, and an image;
monitoring the device for user input, the user input comprising at least one of a touch-based input or a button-based input;
establishing a neutral position of the device upon completion of the user input;
determining a motion of the device relative to the neutral position of the device; and
visually scrolling through the stack of items in response to the motion of the device,
wherein a direction of the scrolling corresponds to a direction of a tilt of the motion of the device.

21. The machine-readable medium of claim 20, wherein the motion comprises at least one of a velocity of the device and an angular displacement of the device, and wherein the instructions further comprise code for receiving the velocity from an accelerometer of the device.

22. The machine-readable medium of claim 21, wherein the instructions further comprise code for determining the angular displacement of the device relative to the neutral position based on the velocity of the device, and wherein the stack of items is visually scrolled through based on the angular displacement.

23. The machine-readable medium of claim 20, wherein visually scrolling through the stack of items comprises expanding the stack of items toward a direction of a tilt of the motion of the device.

24. The machine-readable medium of claim 23, wherein the expanded stack of items displays more content than an unexpanded stack of items.

25. The system of claim 1, wherein the scrolling provides a perception that gravity or a centrifugal force has an impact on the scrolling.

26. The method of claim 16, wherein the scrolling provides a perception that gravity or a centrifugal force has an impact on the scrolling.

27. The machine-readable medium of claim 20, wherein the scrolling provides a perception that gravity or a centrifugal force has an impact on the scrolling.

28. The system of claim 1, wherein the scrolling changes an order of the items from a first order to a second order that is a reverse of the first order.

29. The system of claim 1, wherein the scrolling maintains an order of the items.
